(19) United States
(12) Patent Application Publication
(10) Pub. No.: US 2006/0198245 A1
(43) Pub. Date: Sep. 7, 2006

(54) Electronic insect repelling device

(76) Inventor: William S.H. Cheung, London (GB)

Correspondence Address: CONNOLLY BOVE LODGE & HUTZ LLP, SUITE 800, 1990 M STREET NW, WASHINGTON, DC, 20036-3425, US

(21) Appl. No.: 11/068,773

(22) Filed: Mar. 2, 2005

(51) Int. Cl. H04B 1/02

(52) U.S. Cl. 367/139

(57) ABSTRACT

A personal electronic insect repelling device is. An electronic circuit supported to the underside of a brim of a hat produces a sonic signal directed towards the body of a person wearing the hat. The sonic signal has a frequency which repels insects, particularly mosquitoes. The sonic signal is generated by a battery operated oscillator circuit, which drives an electro acoustic transducer for generating the sonic signal. The acoustic transducer is mounted with respect to the hat brim so that substantially all exposed areas of the person wearing the hat are radiated with sonic energy. The sonic signal has essentially the same characteristics as the sound of a male mosquito. The device may advantageously include an indicator to indicate the status of the battery. In this way, the consequences of frequency drift due to low battery voltage can be readily ascertained, and battery replacement effected at the appropriate time.

### BACKGROUND OF THE INVENTION

The present invention relates to personal devices for repelling insects. Specifically, a sonic wave emitting device is supported on a hat brim to repel mosquitoes.

The conventional way for people to repel mosquitoes is to use a commercially available mosquito repellant spread on vulnerable areas such as the face and arms. However, for some individuals, these repellants may cause irritation and rashes. Consequently, these exposed areas if untreated are prime locations for attack by mosquitoes.

It is known, that female mosquitoes will attack humans and extract blood once they have laid their eggs. At the same time, however, female mosquitoes are no longer interested in associating with male mosquitoes, and will avoid them. If the female mosquitoes detect the sound of a male mosquito, they will fly away and avoid the area where male mosquitoes congregate.

The male mosquitoes generate an ultrasonic signal of approximately 22 KHZ. The present invention generates a sonic signal which substantially emulates the sound of male mosquitoes, and otherwise repels female mosquitoes from the body. Additionally, other insects also appear to be repelled by this sonic signal.

Accordingly, it is an object of the present invention to simulate the sound of male mosquitoes so that female mosquitoes do not attack human flesh.

### BRIEF SUMMARY OF THE INVENTION

A personal electronic insect repelling device is provided by the invention. An electronic circuit connected to the underside of a brim of a hat produces a sonic signal directed towards the body of a person wearing the hat. The sonic signal has a frequency which tends to repel insects, particularly mosquitoes. The sonic signal is generated by an electronic battery operated oscillator circuit, which drives an electro acoustic transducer for generating the sonic signal. The acoustic transducer is mounted with respect to the hat brim so that substantially all exposed areas of the person wearing the hat are radiated with sonic energy.

The invention advantageously generates an electrical signal at substantially 22 KHz, and then amplifies it to a level for driving the electro acoustic transducer. By maintaining a frequency of substantially 22 KHz, a sonic signal having essentially the same characteristics as the sound of a male mosquito are emulated. The device may advantageously include an indicator to indicate the status of the battery. In this way, the consequences of frequency drift due to low battery voltage can be readily avoided by replacement of the battery.

### BRIEF DESCRIPTION OF THE DRAWINGS

FIG. 1 is the top view of a conventional cap which includes a brim 11 extending forward of the cap; and

FIG. 2 illustrates the underside of the cap, wherein an electronic mosquito repelling device in accordance with the present invention is mounted.

FIG. 3 is a schematic drawing of the circuit used to generate the sonic signal for repelling mosquitoes.

### DETAILED DESCRIPTION OF THE INVENTION

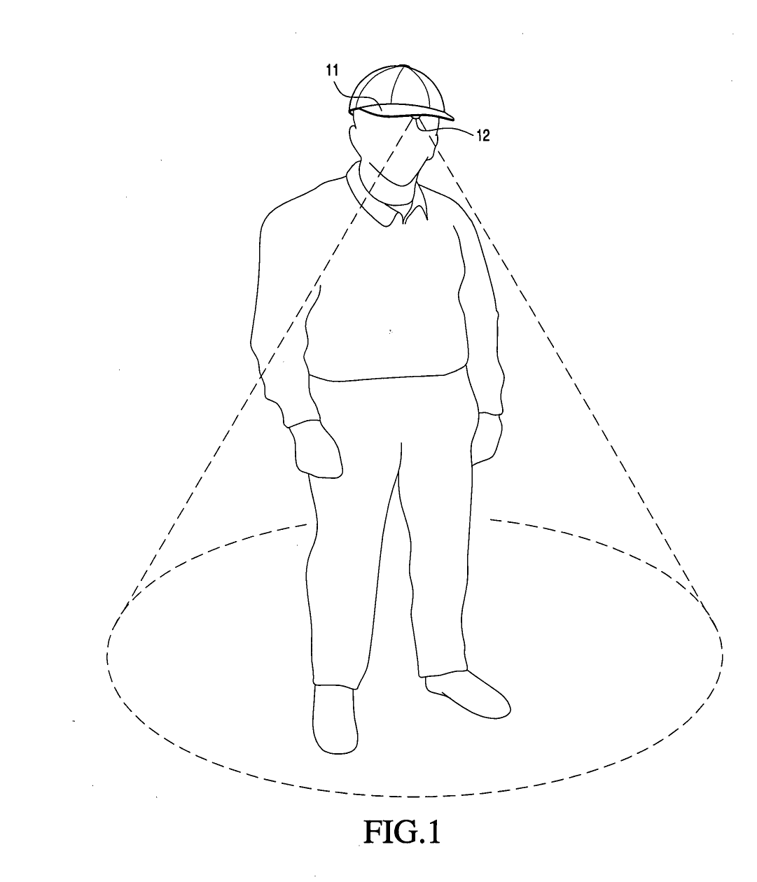

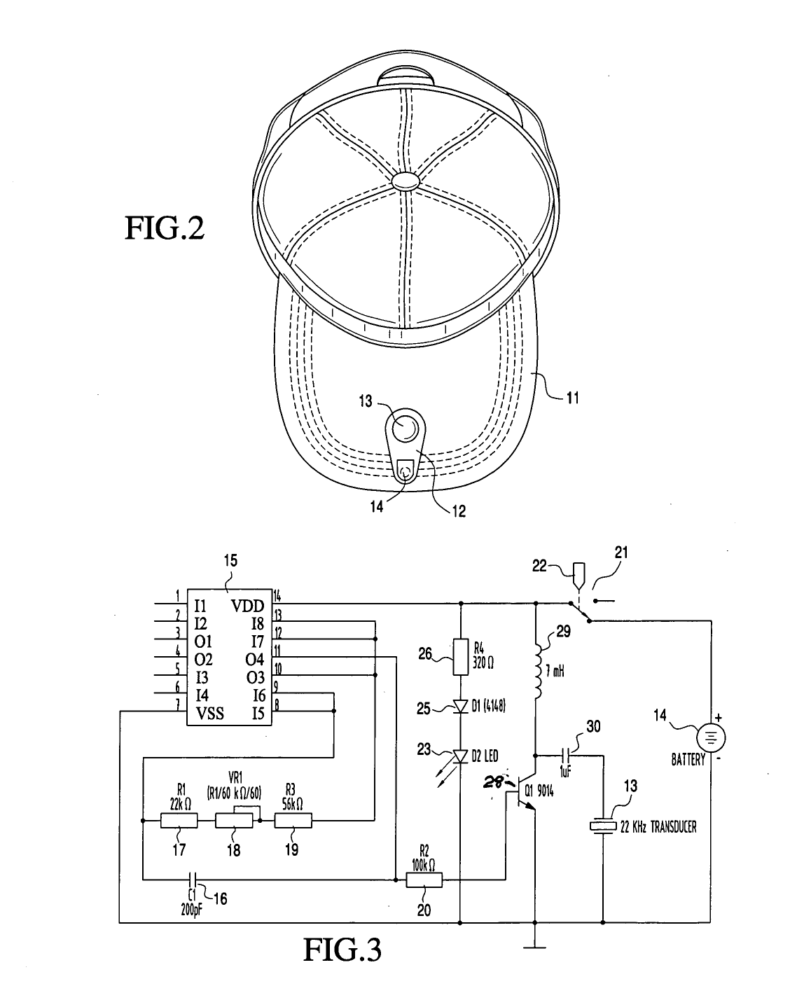

FIGS. 1 and 2 show a hat including a battery operated sonic signal generator 12 for producing sonic energy for repelling insects such as mosquitoes. The sonic signal generator 12 includes an electro acoustic transducer 13 for generating a sonic wave at a frequency for repelling insects. The sonic energy is reflected from the undersurface of the brim 11, and generally forms a diverging cone of ultrasonic energy with a beam width of 60°-80° subject to final hat brim curvature. The sonic energy beam width is adequate to essentially radiate all visible portions of a person's skin with insect repelling sonic energy.

The battery operated sonic signal generator 12 is shown more completely in FIG. 3. Referring now to FIG. 3, an oscillation circuit is shown comprising NAND gate 15. NAND gate 15 is connected to provide an oscillating signal through the use of feedback components, including capacitor 16, resistance 17 and resistance 19. The frequency is trimmed with the variable resistance 18 to obtain a nominal oscillation signal frequency of 22 KHz+/−5%. The oscillating signal is applied through resistor 20 to a power amplifier transistor 28. Amplifier transistor 28 produces a signal on the collector which is coupled through capacitor 30 for driving an electro acoustical transducer 13. Transducer 13 is a standard piezoelectric device for converting electrical signals into acoustic energy. A 3 volt battery 14 supplies voltage through a switch 21. The switch 21 has an actuator 22 extending through the housing of signal generator 12. The battery voltage is applied to the collector of power transistor 28 through an inductance 29 and to the NAND gate 15 to provide power to oscillator circuit.

In accordance with a preferred embodiment of the invention, a battery voltage monitoring circuit is provided. The battery monitoring circuit includes an LED 23 which is viewable through a hole on one side of the sonic generator 12. Diode 25 and resistance 26 limit the current through the LED 23. The frequency of the sonic generator 13 output signal is dependent upon the battery voltage, and its effectiveness in repelling mosquitoes is optimum at 22 KHz. Accordingly, it is advantageous to be certain that the battery voltage does not decrease below a given voltage.

Table 1 illustrates the effect of DC voltage on both power output and the sonic frequency.

TABLE 1

| | DC voltage: | | | | | | |
|---|---|---|---|---|---|---|---|
| | 3.0 | 2.9 | 2.8 | 2.7 | 2.6 | 2.5 | V |
| Frequency | 22.7 | 22.0 | 21.7 | 21.0 | 20.6 | 20.0 | KHz |
| Output Power: | 19 | 19 | 19 | 19 | 18.4 | 18.0 | mW |

When the battery terminal voltage is substantially 3 volts, the LED lights up in a normal way, indicating that the circuit is oscillating at substantially its nominal frequency of 22 KHz. However, when the battery voltage drops to 2.5 volts, the oscillating frequency is shifted down to 20 KHz. At this time, the forward voltage drop across diode 25 plus the drop across resistor 26 will significantly reduce the light output from the LED, indicating to the user that it is time to replace the battery.

The foregoing circuit is useful for providing a battery life expectancy of 50 working hours before it requires replacement. The battery is a conventional CR2016 3 volt DC button cell which is replaceable through an opening in the sonic generator 12.

Thus, there has been described a device for repelling insects which can be worn on a person.

The foregoing description of the invention illustrates and describes the present invention. Additionally, the disclosure shows and describes only the preferred embodiments of the invention in the context of a electronic insect repelling device, but, as mentioned above, it is to be understood that the invention is capable of use in various other combinations, modifications, and environments and is capable of changes or modifications within the scope of the inventive concept as expressed herein, commensurate with the above teachings and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form or application disclosed herein. Also, it is intended that the appended claims be construed to include alternative embodiments.

What is claimed as new and desired to be protected by Letters Patent of the United States is:

1. A personal electronic insect repelling device comprising:
a hat having a generally horizontally extending brim;
an electronic circuit connected to the underside of said brim having a transducer which emits a sonic signal towards the body of a person wearing said hat.

2. The electronic insect repelling device according to claim 1, wherein said transducer emits a sonic signal of substantially 22 KHz.

3. The electronic insect repelling device according to claim 2, wherein said electronic circuit comprises a battery operated oscillator for generating a signal having a frequency of substantially 22 KHz, a power amplifying transducer for amplifying said signal and a piezoelectric transducer for converting said signal into a sonic signal.

4. The electronic insect repelling device according to claim 3, further comprising a visual indicator to indicate the condition of said battery.

5. The electronic insect repelling device according to claim 1, wherein said hat brim and said electronic circuit form a sonic beam having a beam width of substantially 60°-80° subject to final hat brim curvature.

6. A personal electronic insect repelling device comprising:
a circuit for producing a sonic signal including:
a NAND gate connected with timing components to form a oscillator circuit producing a signal having a frequency controlled by the value of said timing components;
a transistor connected to provide power gain to said oscillator signal;
a battery connected through switch means to supply operating voltage to said transistor and said NAND gate;
an audio transducer connected to said transistor to produce a sonic signal; and
means for supporting said circuit over a users body so that said sonic signal is directed towards said users body.

7. The personal electronic insect repelling device according to claim 5, further comprising a voltage monitor for monitoring the condition of said battery.

8. The personal electronic insect repelling device according to claim 6, wherein said voltage monitor comprises an LED which is connected across said battery giving a visual indication of the amount of voltage at said battery terminals.
